(19) United States
(12) Patent Application Publication
(10) Pub. No.: US 2006/0040246 A1
(43) Pub. Date: Feb. 23, 2006

(54) Interactive Toothbrush Game

(75) Inventors: Min Ding, State College, PA (US); Alexander Shtaerman, Landing, NJ (US); Esther B. Scannell, Camarillo, CA (US); Ian A. Almeida, Apple Valley, MN (US); John Romano, Landing, NJ (US)

Correspondence Address: DR. MIN DING / ALEXANDER SHTAERMAN, 408 BUSINESS BUILDING / SMEAL COLLEGE OF BUSINESS, PENNSYLVANIA STATE UNIVERSITY, UNIVERSITY PARK, PA, 16802-3007, US

(73) Assignee: Min Ding, State College, PA (US)

(21) Appl. No.: 11/161,828

(22) Filed: Aug. 18, 2005

Related U.S. Application Data
(60) Provisional application No. 60/602,513, filed on Aug. 18, 2004.

(51) Int. Cl. G09B 23/28

(52) U.S. Cl. 434/263

(57) ABSTRACT

A method and system of promoting effective brushing techniques by coupling entertainment value with the brushing of teeth. The method and system provides for the association of brushing techniques with electronic game tasks. The system can include a toothbrush and a position sensor operatively connected to the toothbrush for sensing movement associated with brushing technique. A gaming interface is preferably in operative communication with the position sensor for providing feedback regarding performance of game tasks and for providing prompting regarding performance of game tasks.

### CROSS REFERENCE TO RELATED APPLICATIONS

This application is a non-provisional application that claims priority of the provisional application for patent entitled “Interactive Toothbrush Game”filed Aug. 18, 2004 by the inventors Ding, Almeida, Romano, Shtaerman and Scannell, U.S. Ser. No. 60/602513.

### FEDERALLY SPONSORED RESEARCH OR DEVELOPMENT

Not applicable.

### SEQUENCE LISTING OR PROGRAM

Not applicable.

### BACKGROUND OF THE INVENTION

1. Field of the Invention

The present invention relates to toothbrushes, and more particularly to a method, system, and apparatus for coupling entertainment value with brushing techniques such that recommended brushing objectives may be accomplished.

2. Description of the Related Art

To ensure proper oral care, dentists recommend that we brush our teeth three times each day for about two to three minutes. Over the years various oral care products have been promoted in recognition of the fact that the average person simply does not devote sufficient time to brushing his or her teeth. While often designed with the goal of elevating cleansing efficiency, many of these products have ultimately met with limited success in improving oral care habits. Please see U.S. Pat. Nos. 6,754,928, 6,611,780 and 6,786,732. With regard to children, who have notoriously short attention spans, progress has been especially hard to come by. Lacking much interest or excitement, a child often views brushing as a chore that need only be performed superficially or not at all. Accordingly, there is a need for a device that can improve upon oral care habits by overcoming the general perceptions that people and especially children have with regard to brushing teeth.

It is a primary objective, feature, or advantage of the present invention to improve upon the state of the art.

A further objective, feature, or advantage of the present invention is to provide a method and system for brushing teeth that increases the interest in brushing teeth, particularly in children, by providing an interactive experience wherein the toothbrush serves as the input device in interactive game tasks to be performed by the toothbrush user in the same fashion a joystick may be used in a video gaming format.

A still further objective, feature, or advantage of the present invention is to provide a method and system for brushing teeth that improves the effectiveness of brushing teeth.

Another objective, feature, or advantage of the present invention is to provide a method and system for brushing teeth that monitors brushing technique.

Yet another objective, feature, or advantage of the present invention is to provide a method and system that provides feedback regarding brushing technique used.

A still further objective, feature, or advantage of the present invention is to provide a method and system that can be implemented in numerous ways with various structures.

One or more of these and/or other objectives, features, or advantages of the present invention will become apparent from the specifications and claims that follow.

### SUMMARY OF THE INVENTION

According to one aspect of the present invention, a method for promoting effective tooth brushing is described. The method couples entertainment value with the brushing of teeth. The method provides for the association of tooth brushing techniques with game tasks. By presenting a toothbrush user with an interactive game task to be performed, the toothbrush user can be prompted to use one of a number of brushing techniques. The toothbrush user's performance of the game task is monitored so that feedback can be provided.

According to another aspect of the present invention, a system for promoting effective brushing techniques is described. The system provides for the coupling of entertainment value with the brushing of teeth. The system includes a toothbrush and a position sensor operatively connected to the toothbrush with the purpose of sensing movements associated with brushing techniques. A gaming interface in operative communication with the position sensor provides feedback regarding performance of game tasks and also provides prompting regarding game tasks to be performed by the toothbrush user. The game tasks are associated with brushing techniques.

### BRIEF DESCRIPTION OF THE DRAWINGS

FIG. 1 is a pictorial representation of one embodiment of the present invention.

FIG. 2 is a pictorial representation of various movements associated with game tasks and corresponding toothbrush movements.

FIG. 3 illustrates a pictorial representation of the mapping of tooth brushing techniques to game tasks.

FIG. 4 illustrates a block diagram of one embodiment of the present invention.

### DETAILED DESCRIPTION OF THE PREFERRED EMBODIMENT

The present invention provides for associating game tasks with brushing techniques in order to promote the proper brushing of teeth. To aid in discussion of the present invention, various embodiments are described. The present invention is not, however, to be limited by the specific embodiments provided. The present invention encompasses numerous variations and additions to what is specifically described herein.

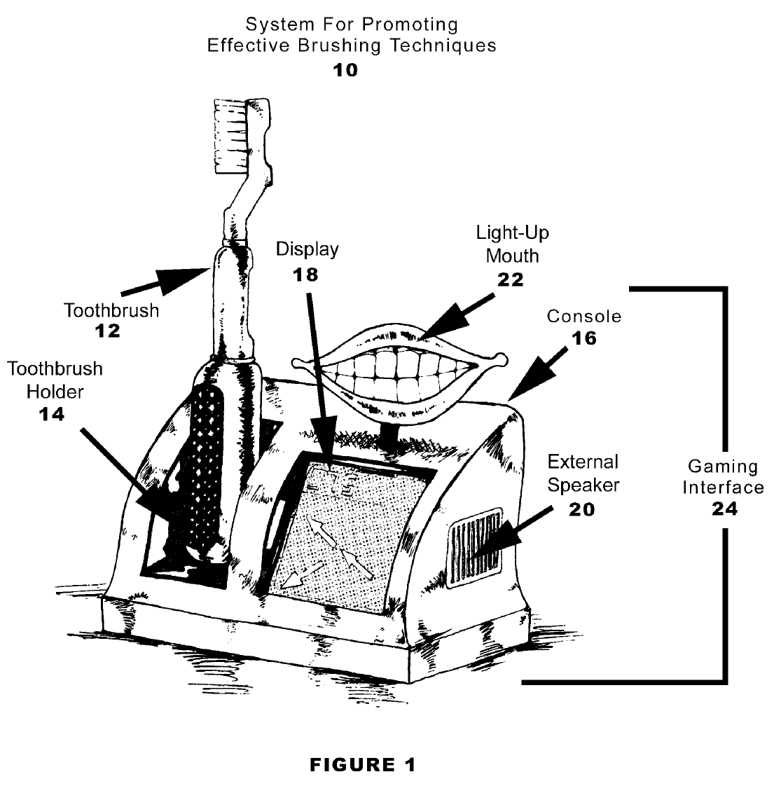

FIG. 1 illustrates one embodiment of a system of the present invention. In FIG. 1, a system 10 for promoting effective brushing techniques is shown. The system 10 provides for coupling entertainment value with brushing of teeth. The system 10 includes a toothbrush 12 which is stored in a toothbrush holder portion 14 of a console 16. The console 16 provides a user interface for game playing or gaming interface by providing a display 18, a speaker 20, and a light-up mouth 22. The gaming interface is generally referred to by reference numeral 24.

In operation, a user of the toothbrush 12 is prompted as to the manner in which to move the toothbrush or the brushing technique to be used. The toothbrush movement or brushing technique is prompted by presenting a game task through the user interface. For example, a screen on the display 18 or a sound produced by the speaker 20 can prompt a user of the toothbrush 12 to perform a particular game task. The game task can merely be to perform a particular brushing technique indicated. Alternatively, the game task can be more complex, such as to control the movement of a game character.

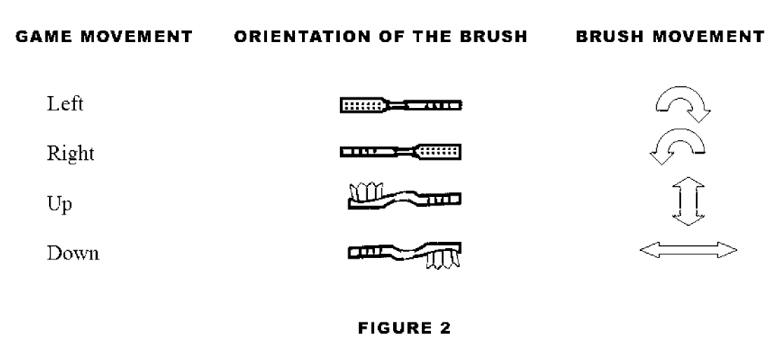

FIG. 2 illustrates one embodiment of how movements of a toothbrush can be associated with game tasks to be performed by the toothbrush user. For example, a clockwise movement of the toothbrush may be required to move a character or a game piece to the left. Similarly, moving a character or game piece to the right may require a counter-clockwise movement of the toothbrush. Similarly, moving a character or a game piece up may require upward and downward movement while moving a character or game piece down may require left and right movement of the toothbrush. Thus, to perform game tasks requires appropriate brushing techniques to be used. The present invention also contemplates that different brushing techniques can otherwise be mapped to game tasks in whatever manner is appropriate. It should be understood that the mapping of game tasks to brushing techniques may depend upon the particular game being played, the particular game tasks associated with the game being played, and the particular brushing techniques that are desired. It is to be further understood that the game tasks can be of various levels of complexity.

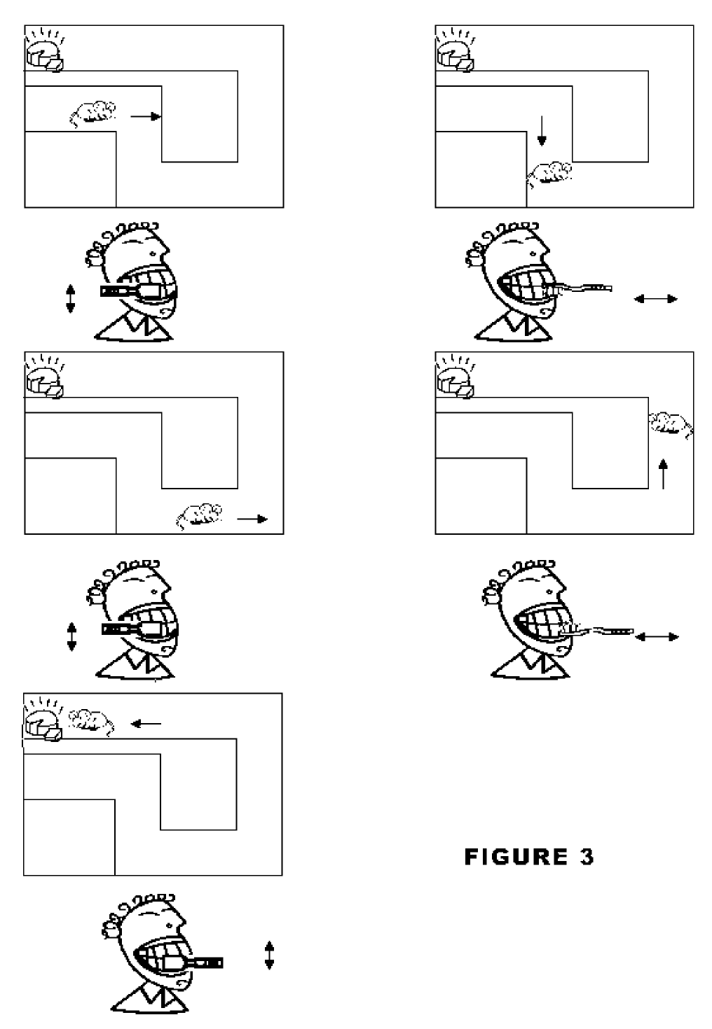

Thus, it should be apparent that the present invention provides for associating game tasks with brushing techniques in order to promote effective brushing. It should be apparent that the present invention is not limited to any particular type of game. In one embodiment, the game can involve traversing a maze in the fashion associated with a PAC-MAN game or other variety of game. The maze is shown on the display 18 and the brushing techniques are used to navigate through the maze. The present invention contemplates that the maze is constructed in a manner that requires effective tooth brushing in order to complete the maze. FIG. 3 illustrates one example of a maze game where a mouse character is moved through a maze to a piece of cheese by requiring a toothbrush user apply appropriate brushing techniques.

Returning to FIG. 1, it should be clear that the present invention can be implemented in numerous ways, with various structures. When a display is used, the present invention contemplates that the display can be an LCD screen, a LED module, or other type of display as may be appropriate in a particular embodiment. The present invention contemplates that a light-up mouth or other elements of a user interface can be used to increase the entertainment value of the system.

The present invention provides for the brushing techniques to be monitored though the use of one or more sensors. The sensors can be of various types, but can include position sensors of any variety in order to monitor position or motion of the toothbrush. The present invention contemplates that other types of sensors can also be used, such as pressure sensors or contact sensors in order to verify that the toothbrush is in contact with the teeth of the user.

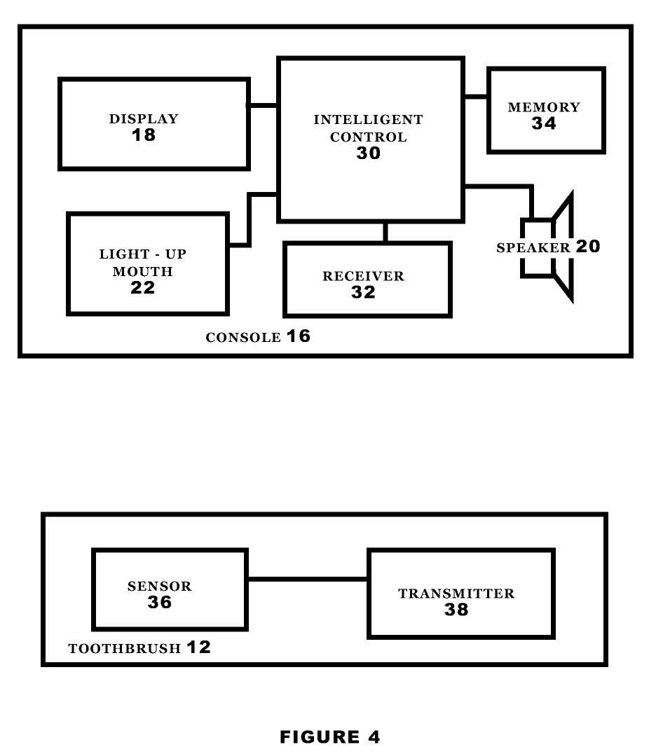

In a preferred embodiment, the toothbrush is in wireless communication with the console. The toothbrush includes at least one position sensor in order to monitor brushing techniques. FIG. 4 illustrates one such embodiment with a toothbrush 12 having a sensor 36 operatively connected to a transmitter 38. Although only one sensor is shown, the present invention contemplates that any number of sensors can be used, including position sensors as well as contact sensors. The toothbrush 12 is in operative communication with the console 16. The console 16 includes an intelligent control 30 such as a microprocessor, microcontroller, Application Specific Integrated Circuit (ASIC), or other type of intelligent control. The intelligent control 30 is operatively connected to display 18, a speaker 20, and a light-up mouth 22. The present invention contemplates that other user interface components can be used in addition to or in place of the display 18, speaker 20, and light-up mouth 22. The intelligent control 30 is also operatively connected to a memory 34. The memory 34 is used to store information regarding one or more games and associations between brushing techniques and tasks. The present invention contemplates that the memory 34 may be configured in numerous ways, including as part of the intelligent control, or as part of an external memory, such as may be stored within a removable game module such that the console 16 can accept different game modules. The present invention further contemplates that due to the use of the intelligent control 30, various additions and modifications can be made as may be appropriate in the context of particular products or as may be desirable to address particular market needs.

By way of example, and without limitation, the sensor 36 associated with the toothbrush 12 can use magnetic sensors (including Hall effect sensors), tilt sensors, accelerometers, or other types of sensors such as may be appropriate in a particular implementation of the present invention. Preferably, one or more sensors allows for the tracking of multi-directional motion of the toothbrush 12. The present invention contemplates that any number of sensing schemes can be used in order to sense brushing techniques.

The present invention further contemplates that the memory 34 can store predetermined brushing objectives, including sets of procedures to be followed for each section of the mouth (i.e. molars, canines, incisors, gums, etc.). The intelligent control 30 is preferably programmed with varying time protocols to ensure that each section of the mouth is brushed for the specified amount of time.

In one embodiment of the invention, the interactive display is activated upon removal of the toothbrush from a holder imbedded in the console 16. In an alternative embodiment, a “start” button is located on the toothbrush or console for initiating prior to brushing. The toothbrush serves as an input device. The display can flash a variety of images based on the orientation of the toothbrush, including “UP”, “DOWN”, “LEFT”, “RIGHT”, and “CIRCLE”. The display can flash arrows corresponding to the directions as well as employ audio commands projected through speaker 20. Thus, the use of the device need not be dependent upon a user's ability to read.

When a user responds to an “UP” arrow appearing on the display by using upward brushing strokes, credit for the motion is recorded. The user continues to respond to the flashing images by moving the toothbrush in the manner prescribed by the display, resulting in a complete cleansing of the user's teeth. In the end, a score can be tabulated based on how accurately a user follows the pattern prescribed by the interactive display. Additional credit may be awarded for performing the various brushing strokes within a certain timeframe (such as approximately two or three minutes).

As previously described, the present invention contemplates the use of various games to indicate appropriate brushing motions to an individual. Examples can include mazes, sports-related games, and the like. There are also existing games that can be adapted for use with the present invention such as PAC-MAN and DIG-DUG. These and/or other games can be stored in a memory which may be, a least in part, a removable module so that games can be interchanged to increase entertainment value.

In another embodiment, a user responds to the directional movement of characters across the display by orienting his or her toothbrush in accordance with an objective of the game. The movement of the various game characters or game pieces corresponds to the predetermined brushing objectives. The user accrues points based on how closely he/she meets the brushing objectives associated with the game format. The sum of these points relates to the effective cleaning of teeth. As users become more adept at brushing their teeth according to the brushing objectives prescribed, they are able to accrue a greater amount of points in the same amount of time. Thus, in this manner, the present invention encourages users to properly complete the mundane task of brushing their teeth by providing an entertaining diversion.

It should be further understood that games used are designed such that recommended brushing movements and recommended brushing time, or other brushing objectives are accomplished. Thus the present invention provides for more than a game, but rather a game designed to complete particular tooth brushing tasks. Although a certain number of various movements may be required, the combination of these movements (thus different sequences) are almost infinite such that a user need not see the same thing again.

The present invention contemplates numerous variations as may be appropriate in a particular application or environment. For example, the present invention contemplates that depending on where a console is used, the console can include water-resistant housing to protect any exposed mechanism. The present invention contemplates that information regarding brushing technique can be stored. The present invention contemplates that there may be additional controls for additional settings. These and many other variations that flow from the disclosure made herein are well within the spirit and scope of the invention.

What is claimed is:

1. A method for promoting effective brushing techniques by coupling entertainment value with the brushing of teeth, comprising the association of brushing techniques with interactive tasks to be performed.

2. The method of claim 1 comprising a system where the toothbrush serves as the input devise for the interactive experience.

3. The method of claim 1 further comprising the prompting of brushing techniques by presenting an interactive task to be performed.

4. The method of claim 1 further comprising monitoring performance of the brushing techniques.

5. The method of claim 1 further comprising providing feedback regarding brushing techniques by providing feedback regarding interactive task performance.

6. The method of claim 3 wherein the step of monitoring is performed using at least one sensor.

7. The method of claim 5 wherein the at least sensor includes a position sensor disposed within the toothbrush.

8. The method of claim 4 wherein the feedback includes producing a sound.

9. The method of claim 4 wherein the feedback includes producing an image on a display.

10. The method of claim 4 wherein the feedback includes the tabulation of a point total.

11. The method of claim 4 further comprising selecting of interactive tasks to be performed to correspond with an effective brushing regimen.

12. A method for brushing teeth, comprising:
Providing a toothbrush;
Associating brushing techniques using a toothbrush with interactive tasks; Monitoring occurrence of the brushing techniques;
Providing feedback regarding occurrence of the brushing techniques by providing feedback associated with the performance of interactive tasks.

13. A system for promoting effective brushing techniques by coupling entertainment value with the brushing of teeth, comprising:
A toothbrush;
A position sensor operatively connected to the toothbrush for sensing movement associated with brushing techniques;
An interactive interface in operative communication with the position sensor for providing feedback regarding performance of interactive tasks and for providing prompting regarding performance of interactive tasks, the interactive tasks associated with brushing techniques.

14. The system of claim 12 further comprising a console, the interactive interface operatively connected to a console.

15. The system of claim 12 wherein the interactive interface includes a display.

16. The system of claim 12 wherein the interactive interface includes a speaker.
